(19) United States
(12) Patent Application Publication
(10) Pub. No.: US 2020/0143261 A1
(43) Pub. Date: May 7, 2020

(54) SYSTEMS AND METHODS FOR PROCESSING CONTENT USING A PATTERN LANGUAGE

(71) Applicant: Unchained Logic, LLC, Washington, DC (US)

(72) Inventors: Justin MORGAN, Ashburn, VA (US); Greg BERRY, Chantilly, VA (US)

(21) Appl. No.: 16/673,687

(22) Filed: Nov. 4, 2019

Related U.S. Application Data
(60) Provisional application No. 62/755,382, filed on Nov. 2, 2018.

(51) Int. Cl. G06N 5/02; G06N 3/04; G06K 9/62

(52) U.S. Cl. CPC G06N 5/022; G06K 9/6264; G06K 9/6215; G06N 3/0454

(57) ABSTRACT

An apparatus, and methods of making and using, to interface with a knowledge providing user and a knowledge acquiring user(s) to provide knowledge in a domain, the apparatus in the form of a embodied computer processor, the computer processor implementing instructions on a non-transitory computer medium disposed in a database, the database in communication with the computer processor, the apparatus comprising: (1) a communication portion that provides communication between the computer processor and electronic user devices; (2) the database that contains a knowledge core; and (3) the computer processor, the computer processor performing processing including: (a) interfacing with the knowledge providing user, having knowledge in a domain area, so as to input first content related to the domain; (b) inputting second content from external sources; (c) combining the first content and the second content so as to generate combined content; (d) processing the combined content using a first neural network and generating an output content; (e) processing the output content using a second neural network, and based on the processing in the second neural network, identifying whether second output from the second neural network is a good pattern or a bad pattern; (f) performing an encapsulation process on patterns that were determined to be good patterns so as to generate encapsulated patterns; (g) compiling the encapsulated patterns to generate a compiled pattern and storing the compiled pattern in the knowledge core; and (h) interfacing with the knowledge acquiring user to retrieve the compiled pattern from the knowledge core, based on interface with the knowledge acquiring user, and present the compiled pattern to the knowledge acquiring user, and the compiled pattern being presented in combination with other compiled patterns provided in the knowledge core.

### RELATED PATENT APPLICATION

This application claims priority to U.S. Provisional Patent Application Ser. No. 62/755,382 filed Nov. 2, 2018 (Attorney Docket 9010-0101) the entire disclosure of which is hereby incorporated by reference.

### FIELD OF THE DISCLOSURE

The systems and methods described herein relate to the collection, aggregation, storage and output of content.

### BACKGROUND

In the present technological environment, various systems and methods are known to assist in the collection, aggregation, storage and output of content. However, known systems and methods lack in the technical approach and efficiency with which collection, aggregation, storage and output of content is performed.

Therefore, technical improvements and solutions are needed to overcome shortcomings that are present in known technology. The systems and methods of the present disclosure provide such technical improvements.

### SUMMARY OF THE DISCLOSURE

An apparatus, and methods of making and using, to interface with a knowledge providing user and a knowledge acquiring user(s) to provide knowledge in a domain, the apparatus in the form of a computer processor, the computer processor implementing instructions on a non-transitory computer medium disposed in a database, the database in communication with the computer processor, the apparatus comprising: (1) a communication portion that provides communication between the computer processor and electronic user devices; (2) the database that contains a knowledge core; and (3) the computer processor, the computer processor performing processing including: (a) interfacing with the knowledge providing user, having knowledge in a domain area, so as to input first content related to the domain; (b) inputting second content from external source; (c) combining the first content and the second content so as to generate combined content; (d) processing the combined content using a first neural network and generating an output content; (e) processing the output content using a second neural network, and based on the processing in the second neural network, identifying whether second output from the second neural network is a good pattern or a bad pattern; (f) performing an encapsulation process on patterns that were determined to be good patterns so as to generate encapsulated patterns; (g) compiling the encapsulated patterns to generate a compiled pattern and storing the compiled pattern in the knowledge core; and (h) interfacing with the knowledge acquiring user to retrieve the compiled pattern from the knowledge core, based on interface with the knowledge acquiring user, and present the compiled pattern to the knowledge acquiring user, and the compiled pattern being presented in combination with other compiled patterns provided in the knowledge core. The disclosure provides variations of such processing, including variance in the input content used in the system.

### BRIEF DESCRIPTION OF THE DRAWINGS

The present disclosure will be better understood on reading the following detailed description of non-limiting embodiments thereof, and on examining the accompanying drawings, in which:

FIG. 1 is a block diagram showing an Artificial Cognition System, in accordance with at least one embodiment of the disclosure.

FIG. 2 is a high-level flowchart showing processing performed by the Artificial Cognition System, in accordance with at least one embodiment of the disclosure.

FIG. 3 is a flowchart showing further details of the Artificial Cognition core processing 300 of FIG. 2 that is performed by the Artificial Cognition System, in accordance with at least one embodiment of the disclosure.

FIG. 4 is a diagram showing further details of the labelled property graph data model of FIG. 2, in accordance with at least one embodiment of the disclosure.

FIG. 5 is a diagram showing further details of the generic knowledge graph of FIG. 2, in accordance with at least one embodiment of the disclosure.

FIG. 6 is a diagram showing further details of the knowledge graphs obtained from documents of FIG. 2, in accordance with at least one embodiment of the disclosure.

FIG. 7 is a diagram showing further details of an interconnected semantic network of FIG. 2, in accordance with at least one embodiment of the disclosure.

FIG. 8 is a diagram showing further details of an open semantic network of FIG. 2, in accordance with at least one embodiment of the disclosure.

### DETAILED DESCRIPTION OF THE DISCLOSURE

Hereinafter, aspects of the systems and methods of the disclosure will be described in accordance with various embodiments.

Cognition can be characterized as a mental action or process to acquire knowledge and understanding through thought, experience, and senses. An early form of knowledge capture was performed by trained scribes producing copies of books written by an acknowledged subject master. The printing press in the mid-15th Century made knowledge-capture available to a wider audience. The printing press and related technology continued as a dominant knowledge—capture technology until the 1980s. Until the digital revolution introduced computers into schools, homes, and businesses, the system for knowledge capture and dissemination changed little. By the time the MS (Microsoft) Office Suite was introduced in the mid-1980s, businesses had already invested billions in IT systems which promised increased productivity with fewer workhours. Consultants such as E. Deming expected a 5-fold increase in productivity, on par with the Industrial Revolution's increase in production.

However, during the last 30 years, productivity has not increased to match expert expectations or the dollars expended. The intellectual property on which businesses rely to produce value mostly remains, for the greater part, in the collective brains of an aging workforce. Most knowledge workers find it increasingly difficult to locate relevant information needed to perform their tasks. As IT systems have evolved rapidly during this period, the documents created to ease knowledge transfer have ever shorter shelf lives. Little content is reused, wasting time and money.

The primary form of storage of a business' intellectual property remains in document form, along with transactional data exists stored in databases. Currently the knowledge needed to effectively retrieve and process these types of stored documents and associated transactional data resides primarily only in the minds of a limited set of workers, knowledge which is lost when those workers leave their projects. Known methods of capturing knowledge residing only in a worker's mind are very time-consuming. These problems primarily stem from our reliance on the traditional medium of knowledge capture and distribution, which is also one of mankind's greatest achievements: the book. In the current age, using the tools available at this time, it is too labor intensive to produce or consume expert knowledge packaged in a static, context free, non-assistive format. What is now needed is a new paradigm.

What is now needed is technology to automate knowledge capture and provide context appropriate distribution, a tool that enhances and intensifies knowledge transfer without human intervention. A tool which can transform or encode existing knowledge into a form that is computable, searchable in context, and easily reused. This disclosure provides the foundation of this tool, a knowledge core. In accordance with one aspect of the disclosure, the disclosure provides a knowledge core that can include an inductive, noSQL, object database with property graph and semantic overlays. In accordance with at least some embodiments of the disclosure, the knowledge core can store a new form of knowledge representation. The knowledge core can store the new form of knowledge representation as pattern objects, with the representation, presentation, active code, security, and other forms of meta-knowledge included in the pattern object itself.

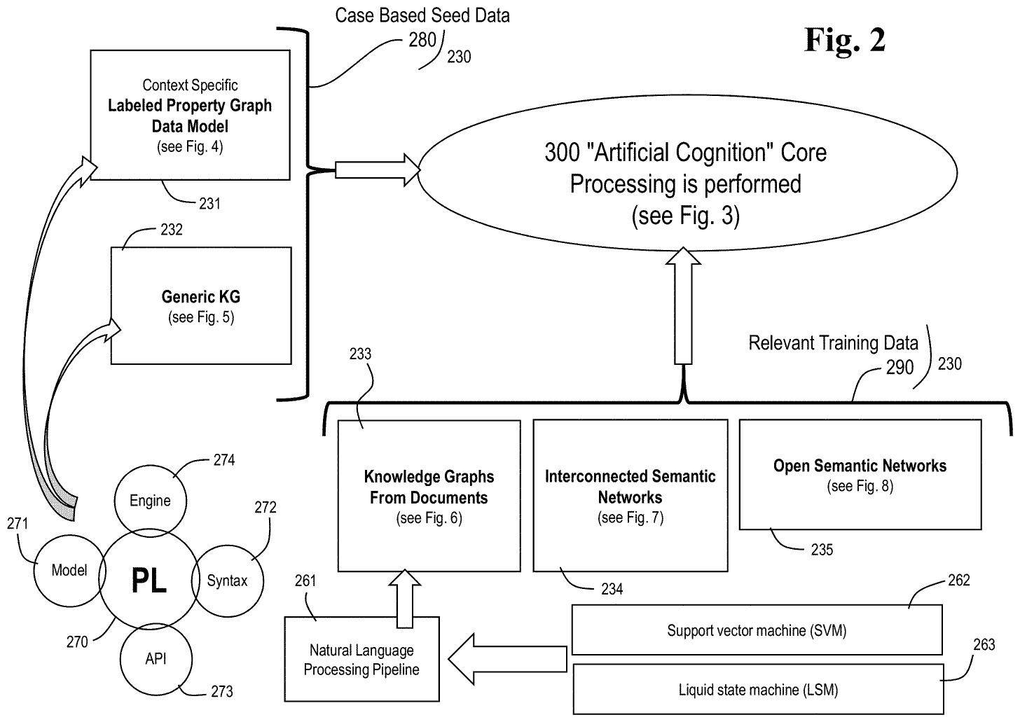

The system of the disclosure can interface with human users, interface with processing components, and/or include processing components that encodes knowledge of a human who has expertise in a particular domain. This expert can be characterized as a “knowledge providing user.” For example, the system of the disclosure can encode the knowledge of a human who has expertise in bridge construction. In other words, the automated system can include a domain expert's knowledge—and does so in specific patterns using a novel pattern language 270 (FIG. 2) that is created for such particular purpose, so as to produce a sparse training pattern (graph).

Other knowledge can be captured with generic scaffolding patterns. Unstructured documents can be converted to a form of a semantic knowledge graph or graphs (234, 235 of FIG. 2) using ontologies to assist with named-entity relationship mapping. General and specific patterns (graphs) can serve as a training set, with one or more adversary neural networks to train capsule neural networks. Trained neural networks can validate suspect patterns made by iterations and create new patterns out of the “rough” (semantic) knowledge graphs that were formed out of the documents. These new patterns can be transferred into the knowledge core of the system and used in future training sets as part of a graph crawling process. The graph crawlers (neural nets) can also intensify existing knowledge in the knowledge core on update cycles of the system. Update cycles can be performed with a set periodicity or at other points in time as may be desired. Users validate the patterns when such users pull the patterns from the knowledge core and/or as such users can “rate” the patterns, i.e. so as to provide a reactive environment. Patterns can also be rated by using other knowledge products or documents. In accordance with embodiments, toolsets can become supervised learning environments for future iterations of learning cycles of the artificial cognition system.

Current state-of-the-art in artificial intelligence is focused on deep learning. Deep learning can be characterized as a machine learning (ML) process using neural networks, which approximates solutions iteratively. These tools provide the speed to tackle large problems that would occupy many workhours to complete. Current inductive methods (convolutional neural networks) have their limitations. In accordance with at least one aspect, the artificial cognition system of the disclosure focuses on, leverages, and uses spatial reasoning provided by recently revealed capsule networks. However, the invention is not limited to capsule networks and known “spiking neural networks” can be used in lieu or with a capsule network or capsule networks and/or a GAN neural network. The knowledge that is retained in the head of an expert (in a particular domain such as bridge construction, for example) can become multidimensional data sets, in practice of the invention, which have very dense interconnections and layered meanings. Most experts do not possess the time or skills to transfer knowledge, which they possess. Novel graph crawlers, of the artificial cognition system of the disclosure, can create the density needed for useful knowledge transfer. In accordance with at least some embodiments of the disclosure, the system can use a reactive and progressive workflow-based tool suite to capture context and provide timely, valuable knowledge.

In accordance with at least some embodiments of the disclosure, the system can be based on and built on a model-based engineering (MBE) foundation that can provide utility in a wide variety of applications, such as for example government RFx requests. The artificial cognition system of the disclosure can provide a process that allows for a range of writer creativity, while still following a fully configurable workflow, and supporting automatic gathering of dashboard metrics to ensure complete and timely results. The artificial cognition system of the disclosure can provide a product suite that fully supports creation of responses that require only one participant, as well as those that require involvement from multiple participants, multiple departments across a particular company, and/or multiple companies, for example. Embodiments of the disclosure can support both sides of a knowledge-interaction ecosystem including those engaged in the procurement of work or knowledge, as well as those engaged with the providing of work or knowledge.

The artificial cognition system can operate through seamless data-sharing among a cloud-based, knowledge-core content repository, with customizable progressive web app (PWA) viewers, and partly by using progressive workflow and dashboarding systems that can track progress of work being performed, which can eliminate manual status reporting. The artificial cognition system of the disclosure can provide for just-in-time training, as users receive useful, in-context suggestions for current activities, for example. Additionally, in accordance with embodiments of the disclosure, walk-throughs can be scripted to help with on-boarding of new users. Additionally, the artificial cognition system can customize user interface environments for tasks or projects in which a particular user or group of users are currently involved.

In accordance with embodiments of the disclosure, a knowledge core server of the artificial cognition system can store a document's sections (or other knowledge product such as tables or figures, for example,) in distinct, meta-data tagged pieces, so the work of creating a complete product is accomplished in easily distributed, tracked segments. An end result, in accord with one aspect of the disclosure, is that the artificial cognition system provides a fully customized deliverable, created with a flexible process, using templates that automatically validate the completeness and adherence to specifications or directions, for example, from corporate business development, government, or other entity.

Knowledge creation, including proposal or procurement, for example, can be an expensive proposition with various data security concerns associated therewith. With this in mind, the artificial cognition system can provide security of data access as an inherent piece of data transactions. Such can be provided to ensure that only pre-approved employees or other associated persons can view knowledge blocks that are appropriate for the particular user. Accordingly, viewing of knowledge blocks and other information, as well as other aspects of access, can be controlled based on attributes of a particular person, a particular group of people, or a particular organization, for example. The artificial cognition system of the disclosure can provide needed leverage to scale up processes to meet increased demands. Embedded machine-learning components, of the artificial cognition system, can provide the required velocity to meet fast-paced cycles without requiring expert inputs.

The artificial cognition system of the disclosure provides a novel way of representing knowledge in a model like environment using reusable patterns. The systems and methods of the disclosure can be characterized as providing “artificial cognition” and relatedly can be characterized as an “artificial cognition system”.

The artificial cognition system of the disclosure can provide and utilize encoded knowledge projection specification (EKPS). EKPS provides a specification for how to encode knowledge utilizing a computable pattern language.

The knowledge projection compiler (KPC) can compile valuable domain knowledge into an executable form.

Natural language processing (NLP) tools built into the knowledge pattern creation crawlers (KPCC), can create knowledge graphs from unstructured text documents, for example, which are encoded as knowledge objects.

The KPCC can enhance the knowledge objects by employing capsule networks to find, validate, and create new knowledge patterns.

The artificial cognition system can store knowledge patterns, which include representations, logic, and related iconography in an inductive database with a property graph and semantic overlays.

Knowledge patterns (KP) can have integral security built into the knowledge patterns. Such built in integral security can disallow access and/or execution by users who do not possess proper access credentials.

The artificial cognition system can provide an integrated reactive environment. The integrated reactive environment can combine a step/event-based tool suite with the ability to select and interact with the content and execute the knowledge patterns that learns with the users.

The apparatus of the disclosure can perform processing including inputting knowledge content from a knowledge providing source using a pattern language that includes encoding graphs of data into knowledge content. The processing can include compiling encapsulated patterns, with other encapsulated patterns, to generate a plurality of compiled patterns, to provide executable code. The executable code can provide for the interfacing with the knowledge acquiring user.

The artificial cognition system of the disclosure can utilize knowledge projection encoding (KPE). The KPE of the artificial cognition system can provide a rule set and ontology that combines as a knowledge tuple. The knowledge tuple can include an ordered list or sequence of content that includes “context” and “intent”, in accordance with at least some embodiments of the disclosure. In particular, such methodology can provide for graph translation with fuzzy inference capability.

The provided integrated reactive environment can combine a step/event-based tool suite with the ability to select and interact with the content and execute the knowledge patterns that learns with the users.

The Knowledge Projection Encoding (KPE) can be used for translations of knowledge across different domains using adaptive conversion with relevant information. This allows for graph translation with fuzzy inference capability.

The artificial cognition system can utilize the above steps, as well as other processing steps, so as to perform artificial cognition processing.

Hereinafter, further aspects of the systems and methods of the disclosure will be described. As described above, the artificial cognition system can store knowledge patterns, which include representations, logic, and related iconography in an inductive database with a property graph and semantic overlays. As used herein, inductive can be characterized as meaning that queries can be stored in the database, in contrast to a database architecture in which the queries are written outside the database and content of the database does not change as questions are posed to the database. In an inductive database, as used herein, a query can constitute an item in the database. In other words, the query adds to the database and is itself information in the database. Accordingly, users who interface and post queries to the database are indeed adding to the database. Accordingly, every time the database of the artificial cognition system of the disclosure is used, the database gains a certain amount of new human provided knowledge that can also create new computer-generated knowledge patterns.

As described below, the processing of the disclosure can include a compiling of data. Once such data is compiled, the data can be characterized as usable executable code. A language used in practice of the disclosure can be a projection language. Accordingly, such language can be both graphical and textual. A change in a graphical component of such projection language, in accordance with embodiments of the disclosure, will result in a change in the corresponding textual component. Together, a change in a textual component of such projection language, will result in a change in the corresponding graphical component. Accordingly, for example, if an error is produced in a textual component, such will result in an error in a graphical component.

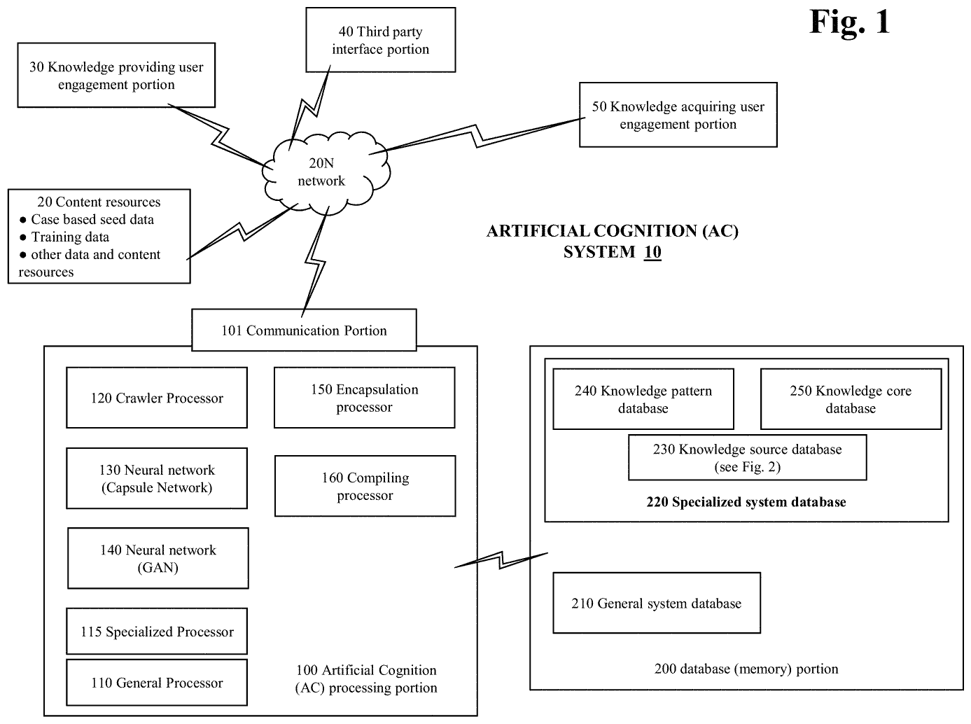

FIG. 1 is a block diagram showing an artificial cognition (AC) system 10, in accordance with at least one embodiment of the disclosure. The system 10 includes an artificial cognition (AC) processing portion 100. The processing portion 100 can include a general processor 110. The general processor 110 can do various general processing of the system. The processing portion 100 can also include a specialized processor 115. The specialized processor 115 can handle various specialized processing performed in the practice of the invention, as described herein, which is not handled by other specialized processors, such as processors 120, 130, 140, 150, 160.

The processing portion 100 can include various specialized processors. These can include crawler processor 120. The crawler processor can handle various processing as described herein, including data extraction and data identification. The processing portion 100 can also include neural network 130 and neural network 140. Such might be characterized as a second neural network and a first neural network or vice versa. The neural network 130 can be in the form of a capsule network or pattern matching neural network. The neural network 140 can be in the form of a generative adversarial network (GAN) or pattern creating neural network in accordance with at least one embodiment of the disclosure. Details of processing performed by such neural networks are described in detail below. The artificial cognition processing portion 100 can also include an encapsulation processor 150. The encapsulation processor 150 can perform processing to encapsulate good patterns as described below. Additionally, a compiling processor 160 can be provided. Once patterns are encapsulated, the patterns can be compiled so as to be usable. In particular, the compile patterns can be human readable and machine computable.

Additionally, the processing portion 100 includes a communication portion 101. The communication portion 101 can provide communication between the processing portion 100 and other systems, processors, databases, sources of content, user devices, and other machines, or any other computing machine or database for example. As shown in FIG. 1, the communication portion 101 may communicate via network 20. The network 20N can include the Internet or any other network as may be desired. In particular, the processing portion 100 can be communication with content resources 20. Content resources 20 are merely illustrative, and the processing portion 100 can be in communication and/or have access to any of a wide variety of databases, data and content sources. As illustrated in FIG. 1, the content resources 20 can include case-based seed data, training data, and other data resources. The artificial cognition system 10 can also include a third-party interface portion 40. The third-party interface portion 40 can provide communication/interface with a wide variety of other systems, databases, etc. as may be desired.

In particular, the communication portion 101 communicates with a “knowledge providing user” engagement portion 30. The knowledge providing user engagement portion 30 interfaces with an expert so as to input knowledge of the expert. For example, the person might be an expert in bridge construction or some other domain. The knowledge providing user engagement portion 30 can be in the form of a computer machine, magnetic resonance helmet, or other user device. The communication portion 101 can also communicate with a “knowledge acquiring user” engagement portion 50. The knowledge acquiring user engagement portion 50 can interface with a human user who wants to acquire knowledge of the system. For example, the engagement portion 50 can include a computer machine. As shown, the engagement portions 30, 50 are in communication with the processing portion 100 over network 20. However, the engagement portions 30, 50 may be in communication with the processing portion 100 in any manner as desired. In particular, the engagement portions 30, 50 may indeed be a part of the processing portion 100.

The AC system 10 can also include a database 200. The database 200 includes the various data utilized and generated by, for example, the processing portion 100 and/or overall system 10. Database 200 can be in the form of data storage units, data modules, data records, or any other type of data storage as may be desired. The database 200 can be in communication with the processing portion 100 in any manner as desired.

The database 200 can include general system data stored in a general system database 210 utilized for general operation of the system 10 and/or the processing portion 100. The database 200 can also include specialized system data stored in a specialized system database 220. The specialized system database 220 can include the various data described in this disclosure including data used by the AC system 10, data generated by the AC system 10, or any other data as may be desired.

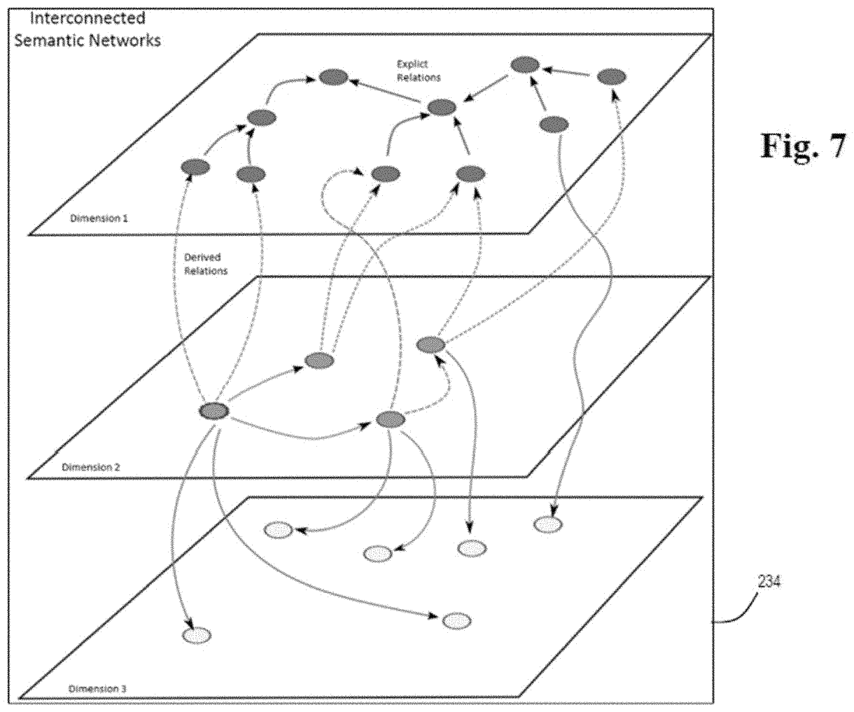

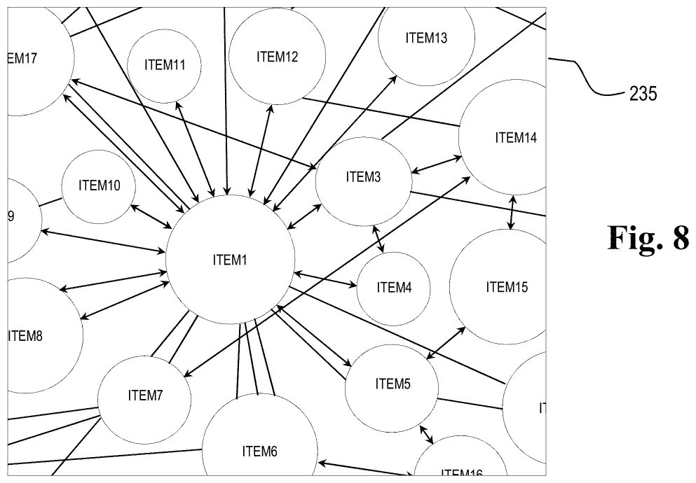

In particular, the specialized data can include data in knowledge source database 230. Such specialized data is shown in FIG. 2, in accordance with at least one embodiment of the disclosure. Such specialized data can include property graph data 231, generic knowledge graphs 232, specific knowledge graphs, knowledge graphs from documents 233, semantic network data 234, 235, and other data. Additionally, the database 200 can include a knowledge pattern database 240. The knowledge pattern database 240 can include pattern data. Processing of pattern data is described in detail herein. Further, the database 200 can include knowledge core database 250. The knowledge core database 250 can, for example, contain compiled data that is usable to interface with a knowledge acquiring user, such as through the knowledge acquiring user engagement portion 50. Such compiling of data and various other features are described in detail below. FIG. 7 is a diagram showing further details of the interconnected semantic network 234 of FIG. 2, in accordance with at least one embodiment of the disclosure. Further details are described throughout this disclosure. FIG. 8 is a diagram showing further details of the open semantic network 235 of FIG. 2, in accordance with at least one embodiment of the disclosure. Further details of semantic networks are described throughout this disclosure.

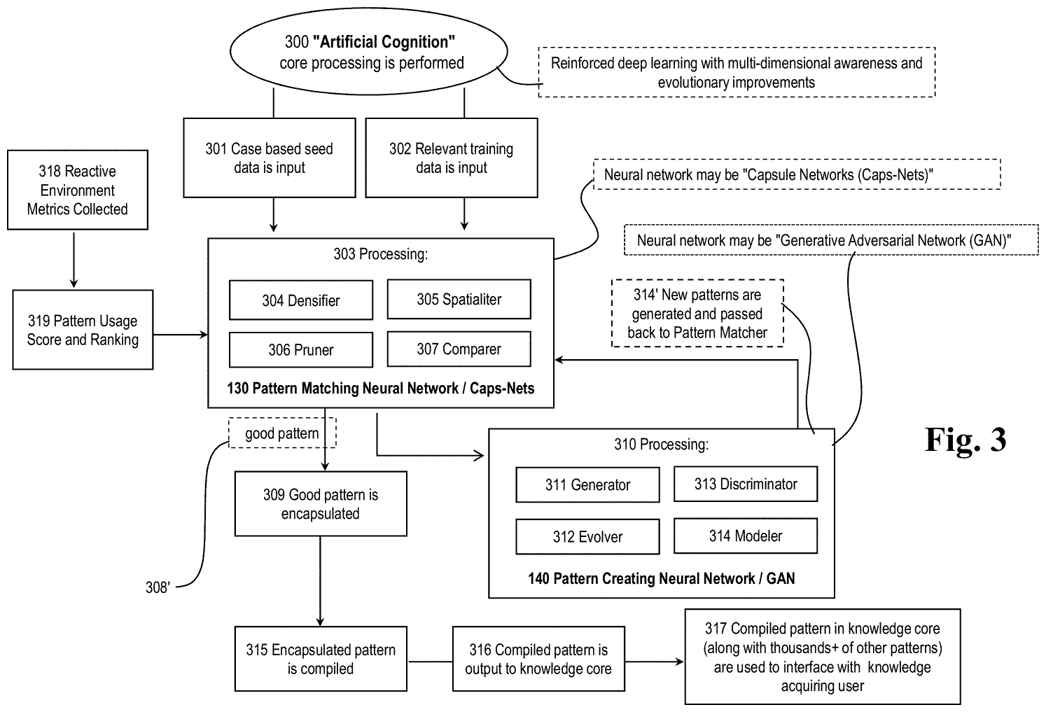

FIG. 2 shows aspects of processing of the artificial cognition system, in accordance with embodiments of the disclosure. As described above with reference to specialized data, FIG. 2 illustrates that various data can be utilized to perform artificial cognition core processing 300. Such data can include case based seed data 280 and relevant training data 290, for example, that can be stored or contained in the knowledge source database 230. Various other data may be utilized. The core processing 300, as described in detail below, may utilize a pattern language (PL) as reflected at 270 of FIG. 2. Various aspects of the core processing 300 are described in detail below with reference to the flowchart of FIG. 3.

As discussed above, in accordance with at least one embodiment of the disclosed subject matter, the artificial cognition system of the disclosure utilizes a pattern language (PL) 270 as reflected in FIG. 2 and as described in detail in this disclosure. The pattern language 270 can be created using a model 271 and/or can be built based on a model 271, as is otherwise described herein. The model 271 can be tailored to a particular domain and/or to an particular expert, for example. Also, the pattern language can use or be based on a particular syntax 272. The syntax that is used in the pattern language, to create patterns based on input knowledge, can be tailored to a particular domain and/or to an particular expert, for example. For example, the particular syntax that is used can be crafted to be particularly conducive for input of knowledge (or type of knowledge) that is common in the particular domain that is being pursued.

The pattern language can use, include, and/or be associated with one or more APIs (application program interfaces) 273. Each of the APIs 273 can be crafted or tailored to input knowledge from a particular respective source into the patterns of the pattern language—so that knowledge from the particular source can be processed so as to further develop knowledge stored by the pattern language.

In accordance with principles of the disclosed subject matter, an engine 274 can be used to create patterns, based on the pattern language. The patterns created by the engine 274 can be further processed by the Artificial Cognition System so as to be usable in accordance with principles of the disclosed subject matter.

The patterns of the pattern language 270 can be used to construct a knowledge graph. The knowledge graph that is constructed can be unique or crafted to a particular domain. The knowledge graph that is constructed can be a specific or domain knowledge graph. As illustrated in FIG. 2, patterns, of the pattern language 270, that are created can be input into a generic knowledge graph (KG) 232 and/or used to evolve a generic knowledge graph 232. The generic knowledge graph 232 and/or a labeled property graph data model can collectively provide case-based seed data 280. Such case-based seed data can be processed by the Artificial Cognition System as illustrated in FIG. 2 and in FIG. 3. Such case-based seed data 280 can be input in step 301 of FIG. 3, for example.

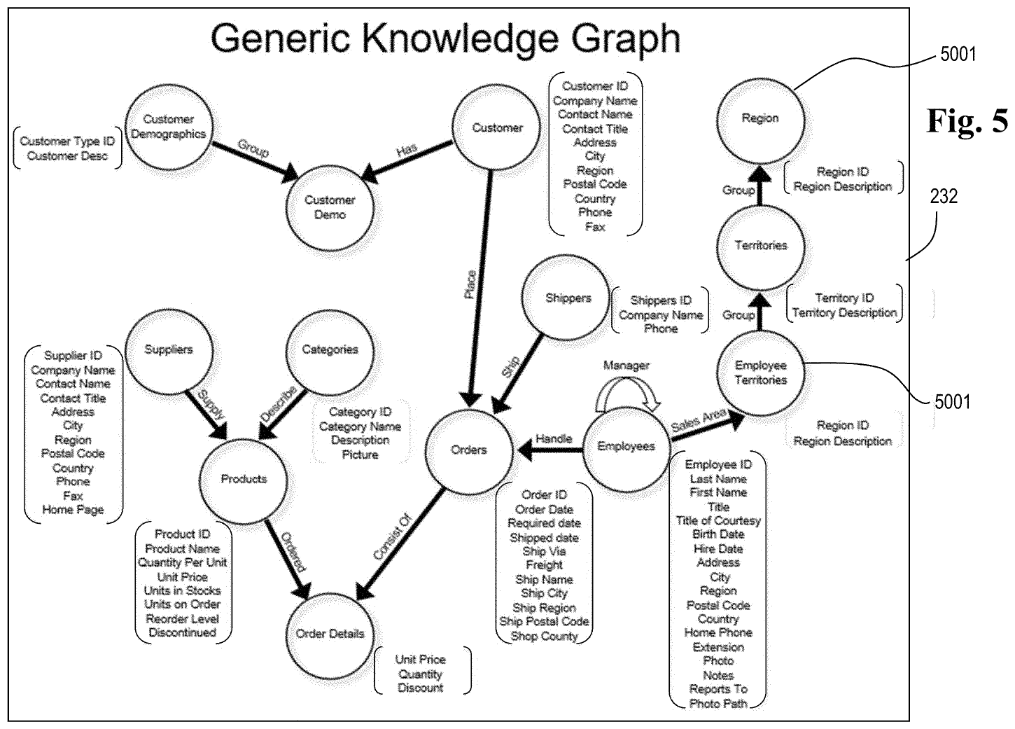

FIG. 5 is a diagram showing further details of the generic knowledge graph 232 of FIG. 2, in accordance with at least one embodiment of the disclosure. The generic knowledge graph 232 includes a plurality of nodes 5001. Related features of knowledge graphs are otherwise described in this disclosure.

In accordance with principles of the disclosed subject matter, various sources of data are described herein as being processed in a particular manner, such as using a particular neural network, and used to render or evolve a particular type of data. For example, data can be input and processed in a particular manner so as to create or evolve patterns of a pattern language. It should be appreciated that processing of particular data can be varied from that described herein. For example, data used as training data in the processing of FIG. 2 might be used as seed data. For example, data used as seed data in the processing of FIG. 2 might be used as training data.

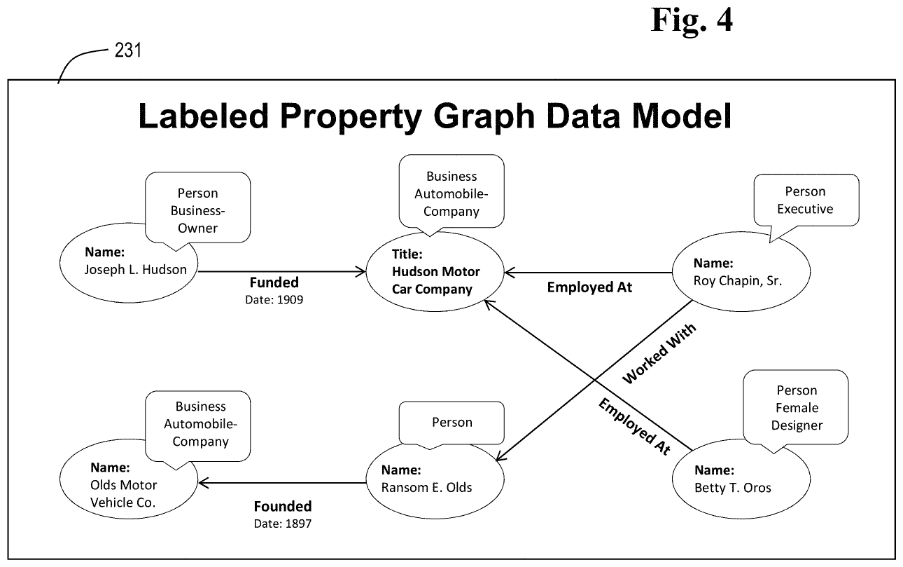

FIG. 2 and FIG. 4 shows a novel form of property graph 231. The novel form of property graph can be created using the pattern language 270 of the disclosure. Data can be taken from existing sources. Based on existing sources, crawlers of the disclosure can produce weak data sets. This weak data is then run through a processing pipeline. In other words, an artificial intelligence pipeline can be provided that creates a new pattern. This new pattern is then compiled.

To explain further, in accordance with at least one embodiment of the disclosed subject matter, the artificial cognition system provides at least two distinct processing components that distinguish it from prior, known systems. Firstly, the manner in which new data sets can be formed and can be compiled in the processing as shown in FIGS. 2 and 3. Further, the patterns, generated with the process as shown in FIGS. 2 and 3 for example, can have a high degree of density, i.e. a high degree of content as provided by the novel processing of the disclosure.

As characterized herein, weak data sets can be understood to be sparse or in other words to possess nodes of data that establishes a relationship between such data, but is limited in details of such relationship.

In processing of the disclosure, machine learning data and/or natural processing language (NPL) data, which is in graph format (and of limited use), can be combined with curated data; such combined data can be run through machine learning of the system; and processing can be performed that results in a pattern. This pattern contains and provides computable data. This pattern contains and provides usable data. Accordingly, the artificial cognition system 10 provides executable models that are of substantial use.

Hereinafter, further aspects of the various levels of the system will be described. Knowledge creation and the processing of knowledge often exists in a scenario in which there is a creator of the knowledge and someone who uses that knowledge, which is created. Accordingly, documentation is created by a first person, or group of persons, that is then used by a second person, or second group of persons, for example. Using existing technology, knowledge is created utilizing various tools. This knowledge is then commonly stored in the form of documents. The documents could be word documents, PowerPoint, Excel documents or other documents. Such documents can include tables, graphs, diagrams and other constructs. However, a problem exists with this approach in that the content of such documents are expressed with natural language. Natural language has limitations. Natural language can be ambiguous, not have context, not have intent, and have limited or sparse information density. For example, content can be ambiguous in that different words can mean the same thing, and same words can mean different things. Further, some word can have a high level of abstraction and thus serve as a source of further ambiguity.

In accordance with at least some embodiments of the disclosures, the artificial cognition system of the disclosure provides extraction tools. Semantic tools or layers, to perform searching, and graph crawlers are provided. These tools actively retrieve information and/or a user imports Word documents or other documents related to the particular domain, i.e. area, that is being worked upon. For example, the particular domain could be “bridge construction”. The system then turns this acquired knowledge into knowledge graphs. Knowledge graphs in general are known. Knowledge graphs can be characterized as including nodes that are nouns and the relationships are verbs, for example. In known knowledge graphs, there is only one verb that the noun is related to.

Illustratively, known modeling languages can include property graph databases and non-property graph databases. Non-property graph databases have one primary element that is a node. Relationships are not a primary element. In property graphs, there are two primary elements. These two primary elements include the node and the relationship. Additionally, there can be provided properties on those elements. These properties might also be characterized as attributes. For example, an adverb is a property on a verb. An adjective is a property on a noun. Accordingly, such additional properties provide the ability to contain and convey additional or denser content. In the invention, natural language processing can be utilized to perform entity extraction. Processing is performed to dis-ambiguize, i.e. make data less ambiguous when read in the form of natural language. Such processing may be characterized as a normalization process in that natural language is taken and put into a structure that adds uniformity and converts implicit knowledge into explicit knowledge such as clearly labeling nouns or verbs. For example, such uniformity might be constituted by a structure that includes noun verb noun; noun verb noun; noun verb noun; . . . and so forth. In this phase of the process, the content is being structured and organized. Accordingly, the content can be organized in a machine-readable fashion, i.e. to possess content that is readable by a computer. Additionally, it is beneficial to provide such data in the form of graphs as opposed to tables, for example. For example, SQL is a table. Specifically, graphs can be beneficial over tables in that inference can be performed if the data is in the form of graphs. Also, additional referential information may be obtained from graphs, as opposed to tables. Accordingly, in embodiments of the disclosure, the system can utilize graphs to represent content.

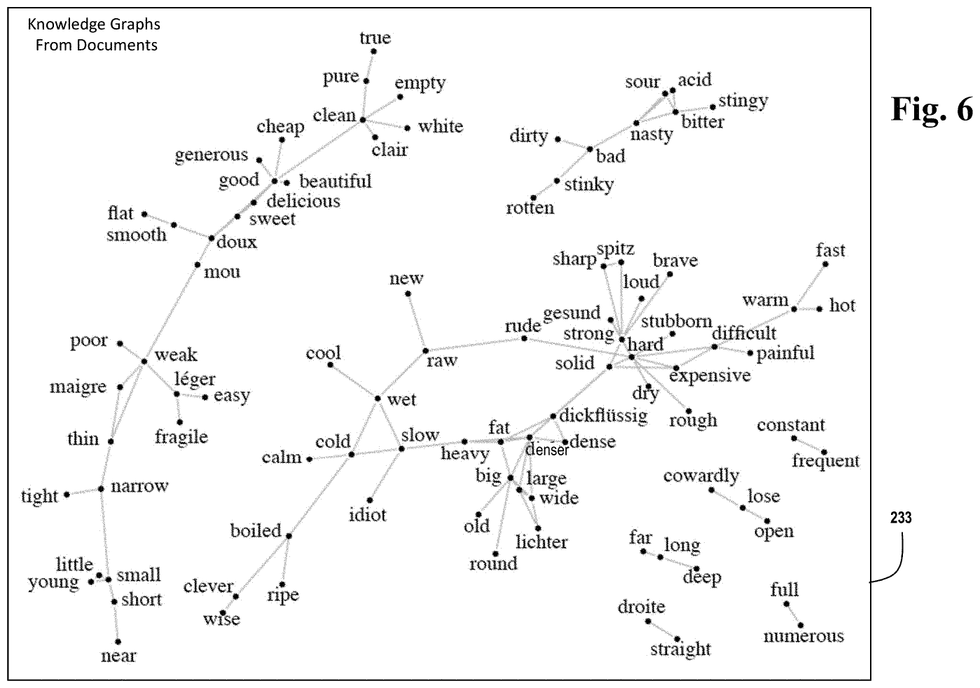

Accordingly, at this point in the processing, the data has been extracted. For example, the data may have been extracted from webpages and/or from documents. This extraction can be performed utilizing a software process that automates the extraction i.e. a crawler. One or more graphs are then produced as described herein, e.g. knowledge graphs 233 can be produced as shown in FIG. 2 and as illustrated in related FIG. 6. That is, FIG. 6 is a diagram showing further details of a knowledge graph 233 obtained from documents of FIG. 2, in accordance with at least one embodiment of the disclosure. Related features of knowledge graphs are otherwise described throughout this disclosure. Accordingly, natural language is converted or processed so as to provide a semi-structured knowledge graph. Accordingly, at this point in the processing the knowledge graph can convey that there is a relationship between content but not “how”, for example, the content is related. In other words, at this point in the processing, we now have a representation of the content that was previously in natural language, and such representation can now be further processed by the artificial cognition system.

In parallel to the natural language processing described above, additional processing is being performed by the artificial cognition system, in accordance with at least one embodiment of the disclosure. In such further processing, the system interfaces with a human. This human can be a domain expert. For example, the human might be an expert in bridge construction. For example, the expert might have 30 years of working in bridge construction. The system can include scaffolding patterns. Scaffolding patterns can be characterized as definitional patterns.

To explain such definitional patterns, illustratively, a question might be posed as to how one defines truth and the definition of truth. To answer such a question, there must be agreement on at least some things. For example, in math, basic equalities are identified and defined. These basic equalities are then built upon. In other words, core truths are provided. Scaffolding patterns provide definitional patterns. The scaffolding patterns, as used in the system of the disclosure, provide a framework or skeleton akin to a scaffolding of a building. The scaffolding provides a set framework with which the expert can work, and which can be built on based on knowledge from the expert. Accordingly, a structure is imposed on the expert in inputting knowledge or content into the system. There is provided a process to capture the expert's knowledge. This process can include a magnetic resonance helmet and/or a computer interface.

To explain further, as described above, the pattern language utilized in the invention can be graphical and textual. The human expert can be exposed to images, and the system can associate (a) an image the human expert was exposed to with (b) a particular magnetic image of the human expert's brain. The particular magnetic image of the human expert's brain can be input utilizing a magnetic resonance helmet, which can identify and/or input magnetic images of a human's brain. To further explain, if the human expert thinks Red Square, a first magnetic image can be identified, utilizing a device such as a magnetic resonance headwear, from the expert's brain. On the other hand, if the human expert thinks blue triangle, a different magnetic image will be identified. Accordingly, the magnetic resonance headwear (or other device to input a magnetic image of the brain) can provide images that are different based on what the expert's brain is exposed to. In other words, the processing of the disclosure can identify differences in what image the human expert sees and map each pattern, to which the human expert is exposed, to a particular brain image. The images can, of course, be much more complex than this simple example. In the processing of the disclosure, images on top of images on top of images, and further can be used. Such might be thought of as a word, with a particular font, that is bolded. Such might be characterized as at least 3 images. For example, a pattern language for a particular domain might include patterns that represent terms of art. The patterns for terms of art can constitute a layer of information or data. Additional details, in the same language, can be layered upon such details. Accordingly, multiple levels of details can be represented by the pattern language of the disclosure. For example, such terms of art might constitute, or be included, in the seed data as input in step 301 of FIG. 3.

Illustratively, an aspect of such processing might be thought of as being akin to aspects of music. A note is a letter, i.e. it is one thing. A cord is 3 notes played at the same time. Not in succession, but rather at the same time. A stanza in music, yet further in complexity, can include multiple cords. Notes, cords, and stanzas can be represented, both alone and in combination, utilizing patterns of a pattern language, as utilized by the artificial cognition system.

Relatedly, it is an objective of the system of the disclosure, in accordance with at least some embodiments, to enhance information density. For example, think of a key to an automobile. The key has a wide variety of attributes. The key has a length, a color and a thickness. The key has certain buttons that correspond to certain functions. The key can have certain smells depending on who has held or played with the key. The key also has history attached to it, such as a human remembering the time the key was lost, the time the key was manipulated by the owner's son, or other experiences associated with the key. As more and more associations are made to the key, the “information density” associated with the key is increased. In accordance with aspects of the disclosure, the artificial cognition system replicates, or attempts to replicate as best as possible, information associated with an object, for example. In other words, and to explain further, if a human domain expert looks at an object, a particular brain image will be generated. Each object in embodiments of the processing, will be associated with a particular brain image. Just as objects are superimposed in the real world, the brain images, as read by the resonance helmet, can also be superimposed. However, the system of the disclosure can “parse out” observed brain images and map those brain images into the respective objects associated therewith. Relatedly, and to explain yet further, each time the human expert is shown the particular object, the human expert's brain image will be similar. Such holds true when a first object is on a second object is on a third object and so forth. Accordingly, such processing including interfacing with a human expert constitutes a second component or part of input performed by the artificial cognition system. The patterns input from the human expert can be stored in a specific form of a graph, such as a knowledge graph.

The system can take (a) the pattern language input plus (b) the scaffolding patterns which were created by the pattern language, which were created as definitional patterns, in accordance with at least some embodiments of the disclosure. These patterns, that have now been generated by the system, are still relatively sparse. However, these patterns are still much denser than, say, traditional books, for example.

The processing can generate a pattern that is computable and secure. In such processing, a pattern can be housed inside or nested within another pattern. Accordingly, the patterns of the pattern language include such content as context, intent, relations, and other information. Accordingly, at this point in the processing, information is now in the “knowledge core” of the artificial cognition system.

Hereinafter, further aspects of a pattern language as utilized in the artificial cognition system will be described. In the processing of the disclosure, what can be characterized as a “knowledge object” can be utilized. The knowledge object can have other primitive objects attached or associated with the knowledge object. These other primitive objects can include such things as security, logic, representation, and structure, for example. The primitive objects can be associated with or possess numbers, such as 1.7 or 32.5, for example. For each of the primitive objects there can be both a picture, i.e. an icon, and associated code, i.e. text. The picture might be constituted by bars, a picture of an input device, or a picture of another device. For example, there can be 3 or 4 primitives for each knowledge object. Each primitive can have interfaces and code, for example. When the primitives are combined together, the primitives make a knowledge object. When multiple knowledge objects are combined together, a pattern is generated. One knowledge object can only connect to another knowledge object if the respective interfaces, of each knowledge object, connect to each other. In code, this can be characterized as “type checking”. If the interfaces of each knowledge object connect to each other, then the knowledge objects can connect. Once knowledge objects connect to each other, a pattern is generated. Additionally, the knowledge objects that are connected also can constitute a knowledge object. Such further knowledge object can be connected to yet another object. This can generate yet another pattern, and so forth.

Knowledge objects can interface with each other if they are complementary, i.e. have a complimentary relationship, in some manner. For example, if a first knowledge object takes in strings of length 3; and a second knowledge object outputs strings of length 3; then the two knowledge objects can interface. Primitives can, of course, interface in any of a wide variety of manners. Different types of primitives can interface in different ways. Accordingly, interfaces between primitives, and processing performed by the artificial cognition system, might be characterized as “type check” between primitives. Knowledge objects interfacing with each other might also be characterized as “coupling” with each other. If primitives cannot interface or couple in some complementary manner, then such primitives will not connect (or at the least cannot be connected so as to provide a good pattern). Pattern crawlers can be utilized to connect the complementary primitives.

To explain further, each knowledge object can possess at least one icon. When the knowledge objects are coupled, the newly formed knowledge object (constituted by two coupled knowledge objects, for example) possesses a composite icon. The composite icon is constituted by the respective icons of each included knowledge object. That is, another icon is generated (the composite icon) that is more complex than the icons that make up the composite icon. Each pattern can include lines of code, which define interfaces of the pattern, and an icon—and such icon may well be a composite icon. Such icon means or represents the associated lines of code, i.e. such icon “is” the line of code. In other words, the particular icon, or composite icon, is definitionally the associated line of code, in accordance with at least one embodiment of the disclosed subject matter. Such might be thought of as being akin to that a name of a document “is” that document. The code of a particular knowledge object is computable, in accordance with embodiments of the disclosure.

Accordingly, to reiterate, pattern language can be used in the processing of the artificial cognition system that can utilize icons stacked on top of icons, hand-in-hand with primitives stacked on top of primitives, so as to make “bigger and bigger” knowledge objects. In such processing, a result can be to provide a “labeled property graph data model” 231 as shown in FIG. 2 and in FIG. 4.

Hereinafter, further aspects of use of capsule networks and/or other pattern matching neural networks, as shown in FIG. 3, as well as the generative adversarial network (GAN) and/or other pattern creating neural networks, as shown in FIG. 3, will be described.

The artificial cognition system of the disclosure might be characterized as including at least three processing pieces. One piece of the processing is the language itself, i.e. the pattern language, as described herein. A second piece of the processing is the graph crawler, that uses neural networks in a novel way—distinct from processing that has been done in the past. The third part of the processing can be characterized as the “compiler.” Such neural networks might also be characterized as machine learning algorithms.

FIG. 2 is a diagram showing further of processing performed by the artificial cognition system of the disclosure. In accordance with one aspect of the processing, the system can utilize one or more liquid state machines 263. A liquid state machine (LSM) is a type of neural network. An LSM can include a large collection of units, which can be characterized as nodes—or better characterized as “software transformers”. Each node can receive input from external sources as well as from other nodes. What each of the software transformers does is take an input “in”, perform some function or does something with the input, and produces an output. Different software transformers, i.e. nodes, do different things to content that is input into the particular node. The LSM can include connections between the software transformers. These connections can be characterized as “pipes”. Each software transformer can include one or more input pipes and one or more output pipes. As the LSM trains, each of the pipes can either be weakened or strengthened. Weakening a pipe can be described as making the pipe smaller. Strengthening the pipe can be characterized as making the pipe larger. What comes out of the LSM is an answer—to the best approximation that the LSM is capable of picking. Accordingly, training of the LSM can be characterized as getting better at approximating an answer, i.e. providing an approximate answer. The artificial cognition system of the disclosure can use liquid state machines 263 or other neural network types to process domain specific documentation into knowledge graphs 233 (FIG. 2 and FIG. 6). These knowledge graphs 233 can be used as seed data and/or of relevant training data 290 for a capture of domain knowledge in context, in accordance with at least one embodiment of the disclosure.

A support vector machine (SVM) 262 can also be utilized, as illustrated in FIG. 2, so as to provide a learning model that analyzes and categorizes data for classification. For example, data or knowledge can be input into the SVM 262 from documents—and the SVM can serve to generate knowledge graphs 233 based on the knowledge that is input.

Natural language processing (NLP) tools can be used. For example, NLP tools can be built into the knowledge pattern creation crawlers (KPCC). NLP tools can create knowledge graphs from unstructured text documents, for example, which are encoded as knowledge objects. For example, a natural language processing pipeline 261 can be used to create knowledge graphs 233 from unstructured text documents.

In accordance with at least some embodiments of the disclosure, in particular, the artificial cognition system can utilize a generative adversarial network (GAN) 140 as shown in FIG. 3. However, other pattern creating or pattern generating neural networks can be used in lieu of a GAN. The GAN 140 can be divided into two neural networks. The GAN 140 can include inputs and outputs, as well as connecting nodes. In accordance with at least one embodiment of the disclosed subject matter, one of the neural networks performs processing to lie, i.e. the neural network is a liar. The other neural network performs processing so as to tell the truth, i.e. the other neural network is a truth teller. The GAN 140 can be fed a training set. The training set can include what might be characterized as “truth” data and “lie” data. The “lie” data can be constituted by essentially blank or null data. In the GAN 140, the liar neural network will try to lie, and the truth teller neural network will try to tell the truth. The truth telling neural network attempts to get better at telling the truth. The lying neural network attempts to get better at lying. As result of data being fed into the GAN, data will be output from or generated by the GAN. The output can be 1 of 4 assessments, (1) a lie correctly identified as a lie, (2) a lie incorrectly identified as a truth, (3) a truth incorrectly identified as a lie, and (4) a truth correctly identified as a truth. Based on this output, a forcing function, that is utilized to train the GAN 140, can reinforce the GAN where correct assessments are determined, and weaken the GAN where incorrect assessments were determined. Accordingly, the GAN processes inputs, some of which are lies, and some are which are truths, and adjustment to the GAN is performed based on the accuracy of assessment (by the GAN) of such inputs. Such above-described processing can be performed by the illustrated processing components of the pattern creating neural network 140. These processing components include a generator 311, an evolver 312, a discriminator 313, and a modeler 314.

To explain further, the processing of step 310, that provides pattern creating, can include or be associated with various processing components. Such processing components can assist in the work that is performed by the pattern creating neural network 140. A generator 311 can perform processing so as to generate patterns as described herein. Patterns can be generated based on various types of input data. Patterns can be evolved into new and different patterns by an evolver 312. Bad patterns can be input and evolved so as to generate good patterns, as assessed by the neural network 130. A modeler 314 can be provided in the processing 310. The modeler 314 can generate patterns and/or vary a particular model based on input data and models, to which the modeler has access to (such as in one or more databases of the system). Various aspects of models are described herein. The processing 310 can also include a discriminator 303. The discriminator 303 can perform processing to recognize patterns in data and, in particular, to recognize difference in patterns. The discriminator 303 can use differences (in patterns) to more effectively perform generation of new patterns. For example, how close or not close a generated pattern is to existing pattern(s) can be used in generating yet further patterns that might be similar to the generated pattern.

It is appreciated that both capsule networks and generative adversarial networks are known. However, the systems and methods of the disclosure provide a novel utilization of such networks in a manner which is novel and not known.

In accordance with embodiments of the disclosure, the artificial cognition system also includes what might be characterized as a “pattern matcher”. As shown in FIG. 3, the pattern matcher 130 can include or be in the form of a capsule network, i.e. Caps-Nets, or can be another pattern matching neural network. In operation, good patterns and bad patterns are fed into the pattern matcher 130. When a pattern, which can be either a good pattern or bad pattern, is fed into the pattern matcher 130, the pattern matcher can transform such input and subsequently output (the transformed pattern) to the lying neural network. The lying neural network may then present the transformed pattern, to the truth telling neural network, as a lie. That is, the lying neural network will try to bluff the truth telling neural network. The truth telling neural network will then determine whether the transformed pattern is indeed a lie or whether the transformed pattern is a truth. In other words, the truth telling network will determine whether the transformed pattern is true or not.

The truth telling neural network may determine that the transformed pattern is good or in other words that the transformed pattern is true, i.e. a truth. In the case of a true determination, the truth telling neural network will pass the transformed pattern back to the pattern matcher 130. If the pattern maker 130 “matches” the returned pattern (i.e. returned from the truth telling neural network) with criteria of good patterns, then the pattern is approved as a “good pattern”. That is, the pattern maker knows what a good pattern is (and what is not a good pattern) because, for example, good patterns have been provided to the pattern matcher 130. As a result of such processing, a “new” good pattern is generated. In accordance with at least some embodiments of the disclosure, this identification and securement of new good patterns is a core objective.

Hereinafter, further aspects will be described. In traditional deep learning, convolutional neural networks, GANs, least square mods, and related processing there exists a deficiency in pattern matching performed by such mechanisms. The deficiency is that such mechanisms are limited in identifying spatial relations. Illustratively, such mechanisms are weak in identifying the difference between a face in which the eye and nose are switched vis-à-vis a face in which the eye and nose are not switched. In particular, such mechanisms “care” which peaks and valleys are present in the image, but do not care, i.e. are weak in identifying if the spatial relationship (of such peaks and valleys) is different.

That is, in a situation where the peaks and valleys are still present—but in a different place on the particular image—the noted mechanisms are limited in identifying such distinction. Such might be characterized as providing a local optimization versus full picture or global optimization. To yet further explain, a movement of peaks and valleys around can be difficult for such mechanisms to identify as a difference.

A capsule network addresses this deficiency. That is, capsule networks address this problem in spatial relationship. A capsule network is a form of deep learning, i.e. things inside of things in an inductive deep learning environment. In a capsule network, processing is provided so as to keep track of the spatial relationship between peaks and valleys. This can be performed in any number of dimensions. Such as in contrast to human processing that generally only relates to 2 or 3 dimensions. However, the artificial cognition system of the disclosure “cares about” and works with hundreds of dimensions. The following is the reason why. To work with an example, in engineering or medicine, for example, there exists different domains of information. Even within a specific area, of engineering for example, there may be several domains. However, all that information in one domain has some relationship or interrelationship to information in other domains of information. Every domain of information can be characterized as a dimension. These can be represented as vectors, i.e. in vector space and the computer or processor is enabled to process these many dimensions. A support vector machine (SVM) 262 can be utilized, as illustrated in FIG. 2, so as to provide a learning model that analyzes and categorizes data and assists in the representation of knowledge using vectors.

In the processing of the disclosure, the processor (of the artificial cognition system) can determine if a knowledge pattern is good. Specifically, for example, if a knowledge object exists on one dimension/domain (with a pattern) that matches (or is similar to) the pattern of a knowledge object on another dimension/domain, then the knowledge object is likely “good”. This can be particularly true if a pattern of knowledge object matches the pattern on a scaffolding knowledge object. And “good” can be understood to be a reasonable approximate answer, i.e. as good of an answer as can be obtained. Or in other words, as good of an answer as can be obtained at the time of training.

To explain further, knowledge objects can be assessed as matching sufficiently (or not) based on a “relationship” in conjunction with the “strength” of the relationship between such two knowledge objects. To assess the relationship between knowledge objects, a fuzzy logic approach can be utilized. This fuzzy logic approach can be based on a range as may be desired. For example, the range might be 0 to 1, wherein 0 indicates no correspondence and 1 indicates complete correspondence or match, or some other range may be used.

In general, in the processing of the disclosure, the system can determine whether a pattern under consideration is “good” or not good based on the similarity of the pattern and/or the knowledge objects that make up the pattern in conjunction with the dimensional space that the pattern/knowledge objects occupy. For example, if a pattern under consideration is deemed similar to a known good pattern—and the two patterns are in a different domain, then the pattern under consideration may well be deemed a good pattern. This is because the observed similarity across different domains is effectively evidence that the pattern under consideration is a good pattern.

Additionally, other processing can be performed to determine if a pattern under consideration is indeed a good pattern. For example, if a pattern under consideration is similar enough to a known good pattern—and both patterns are in the same dimensional space—then the pattern under consideration may be deemed a good pattern.

As described above, the processing to perform whether a pattern under consideration is a good pattern can utilize thresholds and can be based on a matter of degree. For example, if no good patterns are identified over a period of time, thresholds can be adjusted by the system so as to identify a greater number of good patterns. Relatedly, it is appreciated that what is a good pattern is a matter of degree.

The “strength” of a relationship can be made up of context and intent attributes, in accordance with one or more embodiments. However, in other embodiments of the disclosure, different attributes may be utilized to determine “strength” of a “relationship” between knowledge objects of a pattern.

As described above, knowledge objects of a pattern can be compared to determine the similarity of the knowledge objects as well as to assess respective domains of knowledge objects.

Additionally, knowledge objects can be compared based on what is not known regarding the knowledge objects. For example, comparison of a knowledge object of which little or no information is known by the system can rank lower on a given range then comparison of a knowledge object of which some information is known. Knowledge objects can be compared to determine the degree to which a new knowledge object agrees or is aligned with existing knowledge objects. Also, a determination can be made regarding how relevant a new knowledge object is to existing knowledge objects. A knowledge object that is very relevant may be considered more favorably to be a good knowledge object.

Accordingly, using the processing as described above, a pattern can be deemed a good pattern. Then, as a next step, processing can be performed to determine how much of a pattern will be retained. This might be characterized as an “encapsulation” process that is performed in step 309 of FIG. 3. A pattern can be characterized as including nodes extending along branches of the pattern. Indeed, in accord with one aspect of the disclosure, a determination of whether nodes/branches are sufficiently close can be utilized to determine if such collection of nodes constitutes a pattern in the first place.

In the determination by the system of how much of a “good” pattern to retain, a plurality of nodes positioned along a “branch” of a pattern are assessed, in accordance with one or more embodiments. Of those plurality of nodes, illustratively, assume node A is connected to node B based on relationship 1. Node B is connected to node C based on relationship 2. Node C is connected to node D based on relationship 3. Given a starting node, as described below, the strength of nodes out on a branch can be characterized as a summation of each of the relationships of the particular node from the start node. Accordingly, at a point, a node that is sufficiently far out in the branch will possess a summation of relationships (which separate the particular far out node from the start node) that is low. This low summation of relationships will be deemed to be below a threshold. As a result, that far out node will be cut off. In this manner, a pattern identified as a good pattern can be truncated or pruned as can be performed in the processing of a pruner 306 of FIG. 3. The other various branches of a pattern, originating from a start node, can be cut off in similar manner. This truncation of the various branches of a pattern results in a “computable” pattern.

To explain further, a branch may be characterized as a continuous line of nodes with respective relationships (and associated strengths of those relationships) between two adjacent nodes. If a node under consideration is far enough removed, based on the respective relationships of the intervening nodes and the strength of those relationships, from the start node—then that node will be “cut off”. Threshold value or values can be utilized to determine if a particular node is far enough removed (based on relationship/strength of relationship) so as to be cut off. Accordingly, in this manner the “branches” of the pattern can be truncated. In this manner, the pattern can be encapsulated. Without this process, the branches of the pattern can go on forever, although possessing a weaker and weaker relationship to the start node.

Hand-in-hand with determining where to cut the branch or branches of a pattern, determination is performed by the processor to determine what node of the pattern is indeed the start node. As described above, the system can compare a pattern under consideration vis-à-vis a known good pattern to determine similarities therebetween, together with domain characteristics of the pattern under consideration. Based on such processing, a new pattern can be identified as a “good” pattern. The system can make this determination of whether a pattern under consideration is good or not based upon the knowledge objects, i.e. nodes, that make up the particular pattern under consideration. The knowledge object that is most similar or in some other manner “dominant” can be used as the above described “start node.” Such start node can be used in the encapsulation of an identified pattern, in accordance with one or more embodiments of the disclosure.

Once a pattern is encapsulated, further processing is performed upon the encapsulated pattern, in accordance with one or more embodiments. That is, as a result of the encapsulation process, a new unique pattern has been created by the system. The system then “compiles” that new pattern, as is performed in step 315 of FIG. 3. Such compiling of the new pattern can include the system giving the new pattern a name or icon. The system can also give the new pattern primitives such as security (to control who has access to the pattern and the degree of access) and various other attributes. As a result, the pattern, which was encapsulated, can be compiled into a “computable pattern”, i.e. the pattern is machine computable and secure, as well as being human readable. Accordingly, the pattern is now a usable pattern. Compilation of the pattern that was encapsulated, might be characterized as a finishing step so as to prepare the new pattern for usability. The compiled pattern can also be provided with a block chain barcode, for example, so as to make the compiled pattern unique, in accordance with embodiments.

As referenced above, FIG. 3 is a flowchart showing details of the artificial cognition core processing is performed step 300 of FIG. 2, in accordance with at least one embodiment of the invention. As shown, the process can be initiated and pass to steps 301 and 302. Step 301 reflects that case-based seed data is input by the system. Such seed data can be used to develop scaffolding of a domain upon which other data is connected, for example. Step 302 indicates that relevant training data is input by the system. Such training data can be used to train the system. Details are described otherwise herein. The case-based seed data input in step 301 can include the case-based seed data 280 of FIG. 2. The relevant training data can include the relevant training data 290 of FIG. 2.

Processing is then performed by the capsule network (step 303). To perform pattern matching in step 303, the pattern matching neural network 130 can utilize a densifier 304, a spatialiter 305, a pruner 306, and a comparator 307.

To explain further, the processing of step 303, that provides pattern matching, can include or be associated with various processing components. Such processing components can assist in the work that is performed by the pattern matching neural network 130. A comparer 307 can perform various processing associated with comparing patterns. Such comparing is otherwise described herein. Such comparing can include comparing a candidate pattern, under consideration, to known patterns—so as to determine if the candidate pattern should be deemed a good pattern. If deemed a good pattern, the candidate pattern can then be encapsulated (step 309 of FIG. 3) and compiled (step 315 of FIG. 3). The processing of step 303 can also include a pruner 306. The pruner 306 can prune a pattern that is being processed by the pattern matching neural network 130. Once a particular pattern is pruned, the pattern can be compared (by the comparer 307) to determine if such pattern should be deemed a good pattern. Iterative pruning and comparing can be performed. The processing of step 303 can also include a densifier 304. The densifier 304 can perform processing to enhance or vary density that is associated with a pattern. For example, density that is associated with a candidate pattern, under consideration to be deemed a good pattern, can be adjusted, such as for purposes of comparison. The processing of step 303 can also include a spatializer 305 that can be provided. The spatializer 305 is an example of a resource or accessible library that can be provided to the processing 303 so as to expand the abilities of the processing 303, for example. For example, the spatializer 305 evaluates the data's current dimension or puts data objects in the optimal data dimensions.

Patterns that are not matched in the processing of step 303 and/or other patterns can be passed from the pattern matching neural network 130 to the pattern creating neural network 140. In other words, such pattern may not have been deemed a “good pattern” in the processing of step 303 and, as a result, such pattern is passed to the processing of step 310. As described above, in step 310, the pattern creating neural network 140, which can be in the form of a generative adversarial network (step 310), creates a new pattern. Details are described otherwise herein. As a result of such processing, as reflected at 314′ of FIG. 3, in the processing of step 310, new patterns can be generated by the GAN and passed back to the capsule network 130. In accordance with one aspect of the disclosure, in the processing of step 303, the capsule network (i.e. a pattern matching neural network) determines if the pattern that was passed back is indeed a good pattern. The determination of whether a pattern is a good pattern can be performed by a comparer 307, as shown in FIG. 3. If it is a good pattern (308′), then the good pattern is encapsulated in step 309. Then, the encapsulated pattern is compiled in step 315. Then, the process passes to step 316. In step 316, the compiled pattern is output to the knowledge core. Then, as reflected in step 317, the compiled pattern in the knowledge core, which can be disposed in the knowledge core database 250, is used to interface with a knowledge acquiring user. That is, knowledge of the knowledge core of the system can be accessed by a knowledge acquiring user. As reflected in step 317, the compiled pattern is likely utilized in conjunction with thousands or more of other patterns.

As illustrated in FIG. 3 and otherwise described herein, the processing of FIG. 3 can also include the collection of reactive environment metrics in step 318. Such reactive environment metrics may be collected based on observation of use of the system. Relatedly, in step 319, the system can perform pattern usage score and ranking. Such processing can assess utility and value of a particular pattern, group of patterns, and/or type of patterns, for example.

Accordingly, a computer processor of the artificial cognition system 10 can perform reactive processing, the reactive processing including collecting reactive metrics, and the reactive metrics representing interaction of a user with at least one pattern of a plurality of patterns. The computer processor can perform further processing including assigning a score and/or ranking to a particular pattern, based on the reactive metrics, so as to assess validity and/or to verify a particular pattern. The reactive metrics, for a particular pattern, can be based on at least one selected from the group consisting of number of views of the particular pattern, changes to the particular pattern, and time that the particular pattern was viewed.

In accordance with at least one embodiment, the disclosed subject matter can include a process for encoding knowledge representation using a machine computable and human readable pattern language. The pattern language can be in the form of a projection.

Such projection can include bi-directionally linked graphical and textual objects, i.e. a picture/graphic and text. As provided by the disclosed processing, a change of the picture/graphic can be associated with a change of the text and vice versa. The pattern language can include a domain language that includes context and intent. Context can include or relate to the domain as it pertains to a specific user role, i.e. a filter to create a sub-set of a domain knowledge set. Intent can include or relate to the domain as it pertains to a specific instance of an activity.

In accordance with at least one embodiment of the disclosed subject matter, an Artificial Cognition System of the disclosure can include or use various features. The Artificial Cognition System of the disclosure can also be described as “Unchained Logic” or an “Unchained Logic System”. Features of an Artificial Cognition System or system of the disclosure can include or use the following:

1. Knowledge Pattern Creation Crawler (KPCC): AI/ML code (Artificial Intelligence/Machine learning code) designed to traverse a Knowledge Core and create new and valid EKP, by heuristically combining existing EKO based on their allowable interfaces.
2. Market Place of Patterns (MPP): Means of processing for tagging individual sections (e.g. barcode) of an EKP so that it can be priced for sale/re-sale as a distinct new EKP. (e.g. an EKP may exist that performs multiple unique steps to produce an output, some portion of the EKOs that form the EKP may be sliced/separated from the original EKP to be re-used/re-sold independently or as part of a new EKP.)
3. Knowledge Projection Compiler (KPC): Software compiler specific to a Knowledge Encoding Pattern Language of an “Artificial Cognition System” of the disclosure. An instance of a KPC can turn a knowledge tuple into an EKO and a linked set of EKO into an EKP.
4. Encoded Knowledge Projection Specification (EKPS): Specification for how to encode knowledge as a pattern language.
a. Knowledge Tuple (i.e. Projection) (KT): a tuple consisting of a dynamically created icon/graphic and its matching text. If either icon/graphic or text is changed a new KT is created. The icon/graphic can be a main representation sub-object.
b. Encoded Knowledge Object (EKO): a knowledge tuple (KT) along with security, pricing/value, logic, representation, presentation, content, relationships/links, context and intent information in binary format.
c. Encoded Knowledge Pattern (EKP): A valid graph of EKOs that perform a distinct composite knowledge related function. One or more node(s) in an EKP may encapsulate other EKPs in a nested fashion.
5. Knowledge Core (KC): Unchained Logic software environment (or what can also be described as an Artificial Cognition System environment) for securely storing a knowledge domain as a collection of EKO and EKP, along with other supporting datum such as roles (i.e. actors) and workflows (i.e. recipes). The KC can feed and interact with the RKP. The KC can provide interfaces for inference, search, cataloging, and indexing.
6. Actionable Knowledge (AK): Concept that the knowledge object model is code. That is, once a model is successfully compiled to a series of EKO/EKP it can immediately be used (or can be used) as run-time instructions in workflows.
7. Human-to-Machine-to-Human Knowledge Interface (H2M2HKI): Hardware and software to accelerate knowledge capture and presentation outside the use of a standard keyboard/monitor combination.

### 8. Reactive Knowledge Patterns (RKP): Integration of Functional Reactive Progressive Environment and Encoded Knowledge Patterns (EKP).

In accordance with at least one embodiment of the disclosed subject matter, an Artificial Cognition System of the disclosure can include or use various features. Regarding both components and subcomponents, features of an Artificial Cognition System or system of the disclosure can include or use the following:

1. AI Graph Crawler (that can be or include KPCC)—Can serve as: Classifier, Generator and positive/negative differentiator.
2. Interface Tool (H2M2HKI)—can include a “Rig” composed of Alternate Reality Goggles, haptic or Gesture Interface and can include EEG (Electroencephalography) headwear.
3. Compile process (that can be or include KPC)—Processing details for how to convert knowledge Tuples (KT) (text and icons) to computable graph objects (EKOs and EKPs) that can reside in a Knowledge Core (KC) and serves to perform such processing.
4. Encoding from Human Readable to computable format (HR2CF)—Requires use of EKPS and KPC to transform human readable Knowledge Tuples (KT), with corresponding context and intent, into EKO and EKP
5. Encoding new objects from computable format (KPCC/KPC)—AI Program can combine existing EKPs with “core domain concepts” so as to create a new EKP.
6. Knowledge Projection Encoding (KPE)—Ruleset and ontology can be provided for tuple graph translation with fuzzy inference capability.
7. Computable Pattern Language—Such pattern language can provide a domain language with content and intent.
a. Context and Intent—All activities can exist in a workflow with a role and details to filter presentation of Knowledge Core (KC) content.
8. Visualization—Visualization can provide dynamic and meaningful iconography for creating and utilizing knowledge projections.
9. Security—All EKPS have their own security built in to disallow compilation without proper access credentials, such as, for example, proper access credentials of a user.
10. Marketable (MPP)—Every EKP can have an embedded ownership code for royalty calculation.
11. Environment (KC)—The Artificial Cognition System can include a Knowledge Core Software Environment that allows for reactive interaction (using RKP) and connectivity to other software systems.

Hereinafter, further aspects of processing will be described regarding illustrative use of the artificial cognition system.

The system of the disclosure can be used in a situation in which an expert possesses a body of knowledge and there is a desire or need to capture that body of knowledge. For example, the expert might be a “risk management expert”. The person might be a foremost expert in the world and risk management. The person may have written books, presented training materials, and otherwise output content. However, there are real-world limitations regarding how effective one person can be in conveying his or her knowledge. The system provides the ability for such an expert to encode his or her knowledge into something that is usable by other persons. The artificial cognition (AC) system of the disclosure can provide a representation of the expert's knowledge. In practice of the disclosure, the expert would come to a pattern capture specialist, illustratively. Alternatively, the expert might put on a human machine interface helmet. The expert would then engage in doing a “thing”. The thing could be any of a wide variety of activities or exercises, for example, that are associated with risk management or some other domain that is the subject of interest. For example, the expert might do some risk capturing. The expert would then go through and convey information regarding the various steps of risk capture. The information could be a series of steps and various information and content associated with those steps. The expert could convey information regarding the definitions of things and related sidesteps. The expert could convey information regarding analyses that are done and content that is consulted. A series of questions could be posed to the expert. The pattern capture specialist could guide or coach the manner in which the information is conveyed. In particular, the pattern capture specialist could pose questions to the expert and receive responses. Patterns can then be built out of the primitives and scaffolding that the system possesses. In the situation where the system does not have a scaffolding pattern that matches with a particular “thing”, the system will make up a primitive. For example, the system may not understand what “prioritization process” means but does understand, and possesses primitives regarding, what “prioritization” means and what “process” means. Accordingly, the system can make a new primitive based on the combination of such two known primitives. Accordingly, the system can make the new primitive “prioritization process”. In this manner, the system can evolve. As more and more content is input into the system, this content can be represented as patterns, as described above.

The content that is input from the expert, as well as a wide variety of other content that can be input, is processed as described above and compiled. As result, the collected, compiled content, in the form of patterns, is ready for use. In particular, a person who wants the knowledge of the expert can interface with the artificial cognition system so as to obtain that knowledge. This person might be characterized as a “knowledge acquiring user”. For example, a student may want to do a risk management analysis or learn how to do a risk management analysis. The student can interface with the system so as to obtain that knowledge. The student can present content, i.e. a pattern, to the system that represents what the student wants to learn and/or the system can present patterns to the student to select in some manner. For example, the student might enter a search term and the system retrieves patterns associated with that search term. The system can then present a wide and potentially vast array of other related patterns. The student can then choose patterns of interest in a progressive manner. Accordingly, a substantial amount of knowledge can be conveyed to the student, a human, in a very efficient and effective manner. In accordance with one aspect, the system might be characterized as “walking the student through” content that is of interest to the student. Accordingly, the system can be highly interactive with a human user, such as the student in this example. Additionally, the system can use inference to determine what content might be of interest to the user.

Hereinafter, a further illustrative example will be provided. Say for example, a user interfacing with the artificial cognition system is looking at a pattern related to step 1 of a cooking recipe. The system can understand, by association, that the next step is step 2. Accordingly, the system can present step 2 to the user for her review. However, it may be the case that the user comes into the recipe (i.e. in interfacing with the system) at a midpoint of the recipe. For example, the user might come into the recipe at step 3 of the recipe. In such a situation, the system can map a path between the pattern that has been newly identified by the user and a particular pattern that the system is currently “at”. For example, the particular pattern that the system is currently “at” might be the last pattern presented to the user. In conjunction with such mapping, the system can present all the patterns implicated or included in the mapping to the user. The user can then select the particular pattern (of those presented) that is of interest to the user. Based on the selection, yet further patterns can be presented to the user based on inference, i.e. what the system thinks may be of interest to the user based on the interconnectedness of the patterns. Additionally, patterns can be removed from the interface based on an inference that such patterns are not of interest to the user. In such manner, the system can be highly efficient and effective in presenting content of interest to the user.

As otherwise described in the disclosure, various novel processing is provided by the disclosure so as to provide effective knowledge capture and distribution of that knowledge. Capsule networks (Caps-Nets) and other pattern matching neural networks are known. Additionally, GANs and other pattern creating neural networks are known. However, the manner in which such known arrangements are utilized by the artificial cognition system and combined together to provide a technical solution to a technical problem, distinguish the artificial cognition system from known systems. Additionally, the manner in which such known arrangements are combined together distinguish the artificial cognition system from known systems. Additionally, the flow of processing and the manner in which data is manipulated serves to distinguish the artificial cognition system from known systems. Additionally, the artificial cognition system produces data in a specialized format, i.e. encapsulated and compiled, that distinguishes the system from known systems.

In accordance with a further aspect of the AC system, the system can learn by a user interfacing with the system. For example, interactions (i.e. history) with a user can be retained by the system as new patterns. This history can be saved in the information core of the system. However, such data might be distinguished or different then detail learned, and represented in patterns, from an expert or from content. Such initial learning might be characterized as learning about the truth. On the other hand, patterns generated as a result of the system interfacing with a user might be characterized as relating to a user's behavior or how a user acts. Accordingly, the nature of such information may be different. Accordingly, such content, i.e. patterns, relating to a user's behavior might be characterized as a weaker form of learning.

In accordance with an aspect of the disclosure, different models, respectively composed of patterns and likely thousands (or more) of patterns, can be created to represent the knowledge of respective person(s). For example, a model might be constructed representing the knowledge of the foremost expert in risk management in the world. Another model might be constructed representing the knowledge of the second ranked expert in risk management in the world. Such two models could be substantially different and dependent upon the way in which the two experts interfaced with the system in knowledge capture. One model might be effectively used and received by a particular user. The other model might be effectively used and received by another user. Further, such a “model” of an expert might in a global sense be characterized as a “pattern” in of itself. However, such “pattern” includes many many embedded patterns.

In a further aspect of the system in accordance with at least some embodiments of the disclosure, it is appreciated that the system may or may not convey absolute truths. Relatedly, models that are generated from different experts, in the same area, may in fact differ in content and what the particular models deems correct or not correct. Relatedly, a model of the disclosure can be said to not deal with absolute truth. Rather, the artificial cognition system deals with truth in a particular “context” and with a particular “intent”.

As described above, various content can be input into the system in addition to the content, i.e. patterns, obtained from interfacing with the human expert. For example, knowledge graphs 233 from documents, as shown in FIG. 2 can be input into the system. In general, various sources of expertise and knowledge in a particular domain, for example bridge construction, can be input into the system. Such content can indeed provide a training set for information input from other content. For example, data input from knowledge graphs from documents can serve as a training set of data for knowledge input to interface with the expert. Such provides the benefit of understanding content that the expert provides to the system. For example, if the bridge construction expert indicates “blue steel” in description of a particular process, additional content input into the system allows the system to understand what “blue steel” means. Such meaning is not simply a general meaning, but the meaning can be in the particular context unique to the particular domain and unique to a particular action. Relatedly, the scaffolding, i.e. scaffolding patterns, in accordance with at least some embodiments of the disclosure, can provide base context and intent. Accordingly, the scaffolding can bring knowledge capture, such as is input from books, and input from human expert together. That is, the scaffolding can be used to integrate such two types of content that are input by the system. In other words, the scaffolding or scaffolding patterns can provide base context and intent—and the human expert's contribution (through interface with the system) can bring a higher level or a more refined level of content, in accordance with at least some embodiments of the disclosure.

Relatedly, integration of content that is performed by the system might be thought of in terms of different sized building blocks. The human expert, interfacing with the system, might be characterized as providing content in the form of many 20×20 sized building block. The system can convert each of such 20×20 sized building blocks to 1×1 building blocks, which in total amount to the same knowledge as the 20×20, but which provide a much more complex level of content. In other words, the system can supplement (or associate) content provided by the human expert with a wide variety of content from other sources, such as the knowledge graphs from documents 321. This association can be performed using the processing described above.

In accordance with a further aspect of the processing of the disclosure, the system can get smarter and learn utilizing various techniques. For example, as described above, the system can learn through interfacing with users who use the system. Additionally, the system can get smarter at making new patterns. As described above, the liar gets smarter by fooling the truth teller. The truth teller gets better by detecting the lie of the liar. Such as how both neural networks, as described above, get better. Relatedly, the pattern matching performed by the system can also get better. The pattern matching performed by the system can get better, in accordance with one aspect of the system, by determining if patterns, which have been generated, are indeed used by a user. Such use might be in the form of looking at the pattern, choosing a pattern, or editing a pattern, for example. This information, relating to use of a pattern, can be fed back into the information core (step 310 of FIG. 3) and factor into the processing and generation of new patterns. In accord with one aspect of the system, such feedback, into the system, of use of the patterns may require and/or be associated with a recalibration of various parameters of the system. Accordingly, such feedback for “adjustment” of the system may require a shutdown or pause in normal operation of the system. As described otherwise herein, the database of the system can be inductive so as to secure and save data regarding all interaction with the system, including questions asked of the system. This allows the system to perform adjustment if desired, i.e. since the data is available. Such a shutdown or pausing of operations can be accompanied by removing patterns that have not been used. Such a shutdown or pausing of operations can also include an assessment of how the system did in a prior period, for example in the prior 6 months that the system was in operation. “How the system did” can also be assessed based on manner of use by users, extent of use by users, user's interaction with certain patterns and not others, interaction with certain types of patterns and not others, as well as a wide variety of other attributes associated with use of the system. In accordance with at least some embodiments of the disclosure, the system can be calibrated so as to only make new patterns in areas that existing patterns have been used. In other words, the system can be calibrated so as to only make patterns in content areas that are being used. That is, if a user uses a pattern that the system made, then the system knows it did a good job in making that pattern. As result, the system can set parameters and/or parameters can be set so as to make more patterns similar to the pattern that has been used. In other words, a forcing function, provided to the system, can be to make patterns that are used.

To explain further, a forcing function of the liar can be to fool the truth teller. A forcing function of the truth teller can be to detect a lie of a liar. Together, a forcing function of the system overall can be to make patterns that are used. In other words, the system can keep track of how the system makes a particular pattern, and once the system observes that that pattern is used, the system can replicate the manner in which such used pattern was made—so as to make new patterns that will hopefully be used.

Relatedly, the system can observe certain user interaction with a particular pattern or patterns and determine whether the user liked that pattern. For example, such user interaction might include the amount of time that a user spent on a particular pattern. Such user interaction might include the number of times that a user returned to a particular pattern. The artificial cognition system can observe the manner in which a user interacts with a pattern—and if the user performed action that can be understood to be a change in the pattern. A pattern that has been changed can be assessed lower as compared to a pattern that was used without being changed.

Various processing described herein may be performed in an automated or automatic manner. For example, the input of content from databases, identification of patterns, generation of patterns, matching of patterns, neural network processing, testing of patterns, encapsulation of patterns, and compiling of patterns into a usable form, which is processable by a computer machine, can be performed in an automatic or automated manner by the artificial cognition system of the disclosure. Other processing may also be performed in an automatic, i.e. automated manner, as may be desired. For example, the transfer of data between neural networks for processing may be performed in an automated manner. The transfer of data between databases may be performed in an automated manner. Various other processing described in this disclosure can also be performed in an automated manner as should be appreciated by one of ordinary skill in the art given the present disclosure.

The systems and methods of the disclosure provide an innovative technical solution to a technical problem of capturing knowledge and disseminating knowledge in a highly efficient, effective and automated manner. The systems and methods of the disclosure provide an innovative technical solution to a technical problem of effectively inputting, effectively processing and effectively outputting content in a highly efficient, effective and automated manner. The content can be based on and be a representation of a person's knowledge in a particular domain, for example. For example, the person might be an expert in the particular domain. The system of the disclosure can utilize neural networks, machine learning, and related processing in a novel way so as to provide content. The system of the disclosure can use a pattern language to store and convey knowledge to persons who interface with the system. The system of the disclosure can manipulate patterns of a pattern language in ways not currently known including identification of patterns, generation of patterns, matching of patterns, neural network processing, testing of patterns, encapsulation of patterns, and compiling of patterns into a usable form, which is processable by a computer machine. The system of the disclosure can be in the form of a machine. The system of the disclosure can be in the form of an apparatus. The apparatus of the disclosure may be utilized for a wide variety of purposes including the input, storage, and conveyance of content and knowledge in a wide variety of domains and to a wide variety of persons.

Hereinafter, further aspects of the disclosure will be described.

As used herein, any term in the singular may be interpreted to be in the plural, and alternatively, any term in the plural may be interpreted to be in the singular.

It is appreciated that a feature of one embodiment of the disclosure as described herein may be used in conjunction with features of one or more other embodiments as may be desired.

Hereinafter, further aspects of implementation of the systems and methods of the disclosure will be described.

As described herein, at least some embodiments of the system of the disclosure and various processes, of embodiments, are described as being performed by one or more computer processors. Such one or more computer processors may be in the form of a “processing machine,” i.e. a tangibly embodied machine or an “apparatus”. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, code or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example.

As noted above, the machine used to implement the disclosure may be in the form of a processing machine. The processing machine may also utilize (or be in the form of) any of a wide variety of other technologies including a special purpose computer, a computer system including a microcomputer, mini-computer or mainframe for example, a programmed microprocessor, a micro-controller, a peripheral integrated circuit element, a CSIC (Consumer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the disclosure.

The processing machine used to implement the disclosure may utilize a suitable operating system. Thus, embodiments of the disclosure may include a processing machine running the Windows 10 operating system, the Windows 8 operating system, Microsoft Windows™ Vista™ operating system, the Microsoft Windows' XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris' operating system, the OS/2™ operating system, the BeOS™ operating system, the Macintosh operating system, the Apache operating system, an OpenStep™ operating system or another operating system or platform.

It is appreciated that in order to practice the method of the disclosure as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the disclosure, be performed by a single component. Further, the processing performed by one distinct component as described above may be performed by two distinct components. In a similar manner, the memory storage performed by two distinct memory portions as described above may, in accordance with a further embodiment of the disclosure, be performed by a single memory portion. Further, the memory storage performed by one distinct memory portion as described above may be performed by two memory portions.

Further, as also described above, various technologies may be used to provide communication between the various processors and/or memories, as well as to allow the processors and/or the memories of the disclosure to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the disclosure on the processing machine, for example. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the disclosure may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

A suitable programming language may be used in accordance with the various embodiments of the disclosure. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the disclosure. Rather, any number of different programming languages may be utilized as is necessary or desirable.

Also, the instructions and/or data used in the practice of the disclosure may utilize any compression or encryption technique or algorithm, as may be desired. An encryption module might be used to encrypt data. Further, files or other data may be decrypted using a suitable decryption module, for example.

As described above, the disclosure may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the disclosure may take on any of a variety of physical forms or transmissions, for example. Illustratively, as also described above, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the disclosure.

Further, the memory or memories used in the processing machine that implements the disclosure may be in any of a wide variety of forms to allow the memory to hold instructions, data, or other information, as is desired. Thus, the memory might be in the form of a database to hold data.

The database might use any desired arrangement of files such as a flat file arrangement or a relational database arrangement, for example.

In the system and method of the disclosure, a variety of “user interfaces” may be utilized to allow a user to interface with the processing machine or machines that are used to implement the disclosure. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the disclosure, it is not necessary that a human user actually interact with a user interface used by the processing machine of the disclosure. Rather, it is also contemplated that the user interface of the disclosure might interact, i.e., convey and receive information, with another processing machine, rather than a human user.

Accordingly, the other processing machine might be characterized as a user. Further, it is contemplated that a user interface utilized in the system and method of the disclosure may interact partially with another processing machine or processing machines, while also interacting partially with a human user.

It will be appreciated that features, elements and/or characteristics described with respect to one embodiment of the disclosure may be variously used with other embodiments of the disclosure as may be desired.

It will be appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, process step, region, layer or section from another region, layer or section. Thus, a first element, component, process step, region, layer or section could be termed a second element, component, process step, region, layer or section without departing from the teachings of the present disclosure.

Spatially and organizationally relative terms, such as “lower”, “upper”, “top”, “bottom”, “left”, “right” and the like, may be used herein for ease of description to describe the relationship of one element or feature to another element(s) or feature(s) as illustrated in the drawing figures. It will be understood that spatially and organizationally relative terms are intended to encompass different orientations of or organizational aspects of components in use or in operation, in addition to the orientation or particular organization depicted in the drawing figures.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise.

It will be further understood that the terms “comprises” and/or “comprising,” when used in this specification, specify the presence of stated features, integers, process steps, operations, elements, and/or components, but do not preclude the presence or addition of one or more other features, integers, process steps, operations, elements, components, and/or groups thereof.

Embodiments of the disclosure are described herein with reference to diagrams, flowcharts and/or other illustrations, for example, that are schematic illustrations of idealized embodiments (and intermediate components) of the disclosure. As such, variations from the illustrations are to be expected. Thus, embodiments of the disclosure should not be construed as limited to the particular organizational depiction of components and/or processing illustrated herein but are to include deviations in organization of components and/or processing.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

While the subject matter has been described in detail with reference to exemplary embodiments thereof, it will be apparent to one skilled in the art that various changes can be made, and equivalents employed, without departing from the scope of the disclosure.

All references and/or documents referenced herein are hereby incorporated by reference in their entirety.

It will be readily understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. An apparatus to interface with a knowledge providing source and a knowledge acquiring user(s) to provide knowledge in a domain, the apparatus in the form of a embodied computer processor, the computer processor implementing instructions on a non-transitory computer medium disposed in a database, the database in communication with the computer processor, the apparatus comprising:
a communication portion that provides communication between the computer processor and electronic user devices;
the database that contains a knowledge core; and
the computer processor, the computer processor performing processing including:
inputting knowledge content from the knowledge providing source;
processing the knowledge content using a first neural network and generating a first output;
processing the first output using a second neural network, including generating second output;
determining whether the second output from the second neural network is a good pattern or a bad pattern;
determining that the second output is a good pattern;
performing an encapsulation process on the good pattern so as to generate an encapsulated pattern;
compiling the encapsulated pattern, with other encapsulated patterns, to generate a plurality of compiled patterns;
storing the plurality of compiled patterns in the knowledge core, and the plurality of compiled patterns including a first compiled pattern; and
interfacing with the knowledge acquiring user including inputting knowledge request data;
retrieving, based on the knowledge request data, the first compiled pattern from the knowledge core, and
presenting the compiled pattern to the knowledge acquiring user, and the compiled pattern being presented in combination with other compiled patterns provided in the knowledge core.

2. The apparatus of claim 1, the inputting knowledge content includes interfacing with a knowledge providing user, having knowledge in the domain, so as to input first content related to the domain;

3. The apparatus of claim 2, the inputting knowledge content includes inputting second content from text content.

4. The apparatus of claim 3, the computer processor combining the first content and the second content so as to generate combined knowledge content.

5. The apparatus of claim 1, the inputting knowledge content includes inputting content from text content.

6. The apparatus of claim 1, the retrieving the first compiled pattern is performed based on a match between the knowledge request data and the first compiled pattern.

7. The apparatus of claim 1, the first neural network is a pattern creating neural network and the second neural network is a pattern matching neural network.

8. The apparatus of claim 7, the processing further including outputting, from the second neural network, a bad pattern to the first neural network.

9. The apparatus of claim 1, the computer processor performing a pattern evolving process to at least one further pattern, and the pattern evolving process being associated with the first neural network.

10. The apparatus of claim 1, the computer processor further performing a pruning process to a further pattern, and the pruning process including deleting portions of the further pattern so as to render a reduced pattern.

11. The apparatus of claim 10, the pruning process being associated with the second neural network.

12. The apparatus of claim 1, the computer processor performing further processing that includes inputting training data into the second neural network, and the training data provided to train the second neural network.

13. The apparatus of claim 1, the determining whether the second output from the second neural network is a good pattern or a bad pattern is performed using at least one threshold and/or range to compare the second output to known good patterns.

14. The apparatus of claim 13, the knowledge core including a plurality of patterns of a pattern language, and the known good patterns are part of the plurality of patterns of the pattern language, and the plurality of patterns of the pattern language representing knowledge.

15. The apparatus of claim 14, the knowledge is associated with a specific domain.

16. The apparatus of claim 15, at least a portion of the plurality of patterns, of the pattern language, include a plurality of combined patterns, and each of the combined patterns represent an item of information in the domain.

17. The apparatus of claim 14, the computer processor performing reactive processing, the reactive processing including collecting reactive metrics, and the reactive metrics representing interaction of a user with at least one pattern of the plurality of patterns.

18. The apparatus of claim 17, the computer processor performing further processing including assigning a score and/or ranking to a particular pattern, based on the reactive metrics, so as to assess validity and/or to verify the particular pattern.

19. The apparatus of claim 17, the reactive metrics, for a particular pattern, are based on at least one selected from the group consisting of: number of views of the particular pattern, changes to the particular pattern, and time that the particular pattern was viewed.

20. The apparatus of claim 1, wherein the first neural network includes a capsule network; and;
wherein the second neural network includes a generative adversarial network (GAN).

21. The apparatus of claim 1, wherein the inputting knowledge content from the knowledge providing source is performed using a pattern language that includes encoding graphs of data into knowledge content; and
the compiling the encapsulated patterns, with other encapsulated patterns, to generate a plurality of compiled patterns, provides executable code, and the executable code provides for the interfacing with the knowledge acquiring user.
